(19) United States
(12) Patent Application Publication
(10) Pub. No.: US 2024/0351306 A1
(43) Pub. Date: Oct. 24, 2024

(54) THERMAL PROTECTION LAMINATES

(71) Applicant: Blueshift Materials, Inc., Spencer, MA (US)

(72) Inventors: Lawino KAGUMBA, Spencer, MA (US); Marisa SNAPP-LEO, Spencer, MA (US); Vitaly BENKIN, Spencer, MA (US); Hojat MAJEDI FAR, Spencer, MA (US); Garrett POE, Spencer, MA (US)

(73) Assignee: Blueshift Materials, Inc., Spencer, MA (US)

(21) Appl. No.: 18/682,341

(22) PCT Filed: Aug. 9, 2022
(86) PCT No.: PCT/US2022/074726

§ 371 Date: Feb. 8, 2024

Related U.S. Application Data
(60) Provisional application No. 63/231,127, filed on Aug. 9, 2021.

(51) Int. Cl. B32B 7/027; B32B 5/18; B32B 7/06; B32B 7/12; B32B 9/00; B32B 9/04; B32B 15/08; B32B 15/18; B32B 15/20; B32B 27/06; B32B 27/08; B32B 27/18; B32B 27/28

(52) U.S. Cl. CPC B32B 7/027; B32B 5/18; B32B 7/06; B32B 7/12; B32B 9/007; B32B 9/045; B32B 15/08; B32B 15/18; B32B 15/20; B32B 27/065; B32B 27/08; B32B 27/18; B32B 27/281; B32B 27/283; B32B 2264/108; B32B 2266/0214; B32B 2266/06; B32B 2266/102; B32B 2266/104; B32B 2266/126; B32B 2307/20; B32B 2307/302; B32B 2307/304; B32B 2307/3065; B32B 2307/72; B32B 2307/7376; B32B 2307/748; B32B 2605/18

(57) ABSTRACT

A laminate can include one or more thermally-insulative layers, each having a thermal conductivity that is less than or equal to 0.05 W/m·K, wherein the laminate has a thickness that is less than or equal to 500 μm and a thermal diffusivity that is less than or equal to 0.10 mm²/s. The laminate can include an adhesive layer, wherein aback surface of the laminate is at least partially defined by the adhesive layer or a liner layer that is removably disposed on the adhesive layer. The laminate can include a protective layer that defines at least a portion of a front surface of the laminate, wherein the protective layer has a thermal conductivity that is at least 3.5 times the thermal conductivity of each of the thermally-insulative layer(s).

### CROSS-REFERENCE TO RELATED APPLICATIONS

This application claims the benefit of priority of U.S. Provisional Patent Application No. 63/231,127 filed Aug. 9, 2021, which is hereby incorporated by reference in its entirety.

### BACKGROUND

### A. Field of the Invention

The present invention relates generally to laminates for thermal protection in systems such as, but not limited to, aircraft and spacecraft.

### B. Description of Related Art

Systems such as aircraft, spacecraft, missiles, rockets, artillery rounds, or other projectiles may include components that are subject to, and require protection from, high temperatures. Traditional thermally-insulative materials such as foams, polymers, and elastomers may provide some thermal protection, but still face limitations. For example, while polymeric foams have a low thermal conductivity to mitigate heat transfer, their thermal diffusivity—which is a material's thermal conductivity divided by its density and specific heat capacity—tends to be higher than that of other insulative materials. With a higher thermal diffusivity (meaning a higher thermal conductivity relative to the material's specific heat capacity and density), the temperature of such polymeric foams may tend to rise faster such that heat propagates faster therethrough with continued heating. Other polymeric and elastomeric materials may have a lower thermal diffusivity than polymeric foams but tend to have higher thermal conductivities. Additionally, heat concentrated on one portion of such traditional thermally-insulative materials may not be distributed across the surface thereof, accelerating heat transfer through the material's thickness to the surface of the component it is designed to protect. As such, traditional thermally-insulative materials may not provide a level of thermal protection desired in some applications.

Furthermore, in some systems the thermally-insulative material may be subject to tight space constraints. Because traditional thermally-insulative materials are usually relatively thick and/or rigid, such constraints may limit the amount traditional thermally-insulative material that can be included in the system—further limiting the thermal protection afforded by the material—or may render such materials unusable in the system. Compounding these limitations, polymers, elastomers, and foams often have a relatively high coefficient of thermal expansion, rendering the space constraints more restrictive for these materials when heated.

### SUMMARY OF THE INVENTION

There accordingly is a need in the art for materials that provide better thermal protection than traditional thermally-insulative materials, including in applications with tight space constraints. Some of the present laminates address this need in the art by including one or more thermally-insulative layers that each have a relatively low thermal conductivity and thermal diffusivity, such as a thermal conductivity that is less than or equal to 0.05 Watts per meter-Kelvin (W/m·K) (e.g., less than or equal to 0.025 W/m·K) and a thermal diffusivity that is less than or equal to 0.15 square millimeters per second (mm²/s) (e.g., less than or equal to 0.10 mm²/s). And such thermally-insulative layer(s) can each be relatively thin, such as less than or equal to 254 micrometers thick, and/or flexible such that the laminate is usable in confined spaces, allowing the laminate to provide superior thermal protection in systems subject to tight space constraints. Furthermore, each of the thermally-insulative layer(s) can have a relatively low coefficient of thermal expansion, such as one that is less than or equal to 40 μm/m·K, further promoting the laminate's usability in confined spaces. One suitable material for each of the thermally-insulative layer(s) is a layer of polymeric aerogel, such as a polyimide aerogel.

Additionally, some laminates can include one or more adhesive layers, wherein at least a portion of a back surface of the laminate is defined by a first one of the adhesive layer(s) (or by a liner layer that is disposed on the first adhesive layer and can be removed from the adhesive layer to expose it) that can adhere the laminate to a surface for thermal protection. The first adhesive layer can comprise, for example, a pressure-sensitive adhesive, allowing ready application of the laminate to the surface.

Also disclosed is a method of making a layer of polymeric aerogel suitable for use in at least some of the present laminates. The method can include: (a) providing a monomer or a combination of monomers to a solvent to form a solution; (b) polymerizing the monomer(s) in the solution to form a polymer gel matrix; and (c) subjecting the polymer gel matrix to conditions sufficient to remove liquid from the polymer gel matrix to form an aerogel having a polymeric matrix comprising an open-cell structure. Step (b) can further comprise adding a curing agent to the solution to reduce the solubility of polymers formed in the solution and to form macropores, mesopores, and/or micropores in the gel matrix, the formed macropores, mesopores, and/or micropores containing liquid from the solution. The process can include casting the polymer gel matrix in step (b) onto a support such that a layer of the polymeric gel matrix is comprised on the support, wherein the aerogel in step (c) is in the form of a film.

The aerogel's pore structure can be controlled, including the quantity and volume of macroporous, mesoporous, and microporous cells, primarily by controlling polymer/solvent dynamics during formation of the polymer gel matrix. As one example, a curing agent can be added to the solution in step (b) to reduce the solubility of polymers formed in the solution and to form macropores in the gel matrix, the formed macropores containing liquid from the solution. Such a curing agent can be, for example, 1,4-diazabicyclo[2.2.2]octane. Adding a curing agent to the solution in step (b) to instead improve the solubility of polymers formed in the solution, such as triethylamine, will form a relatively lower number of macropores in the gel matrix. In another example, when forming a polyimide aerogel, increasing the ratio of rigid amines (e.g., p-phenylenediamine (p-PDA)) to more flexible diamines (e.g., 4,4′-oxydianiline (4,4′-ODA)) in the polymer backbone can favor the formation of macropores as opposed to smaller mesopores and micropores.

While more specifics about monomers, solvents, and processing conditions are provided below, in general terms, the following can be adjusted to control the aerogel's pore structure: (1) the polymerization solvent; (2) the polymerization temperature; (3) the polymer molecular weight; (4) the molecular weight distribution; (5) the copolymer composition; (6) the amount of branching; (7) the amount of crosslinking; (8) the method of branching; (9) the method of crosslinking; (10) the method used in formation of the gel; (11) the type of catalyst used to form the gel; (12) the chemical composition of the catalyst used to form the gel; (13) the amount of the catalyst used to form the gel; (14) the temperature of gel formation; (15) the type of gas flowing over the material during gel formation; (16) the rate of gas flowing over the material during gel formation; (17) the pressure of the atmosphere during gel formation; (18) the removal of dissolved gasses during gel formation; (19) the presence of solid additives in the resin during gel formation; (20) the amount of time of the gel formation process; (21) the substrate used for gel formation; (22) the type of solvent or solvents used in each step of the optional solvent exchange process; (23) the composition of solvent or solvents used in each step of the optional solvent exchange process; (24) the amount of time used in each step of the optional solvent exchange process; (25) the dwell time of the part in each step of the solvent exchange process; (26) the rate of flow of the optional solvent exchange solvent; (27) the type of flow of the optional solvent exchange solvent; (28) the agitation rate of the optional solvent exchange solvent; (29) the temperature used in each step of the optional solvent exchange process; (30) the ratio of the volume of optional solvent exchange solvent to the volume of the part; (31) the method of drying; (32) the temperature of each step in the drying process; (33) the pressure in each step of the drying process; (34) the composition of the gas used in each step of the drying process; (35) the rate of gas flow during each step of the drying process; (36) the temperature of the gas during each step of the drying process; (37) the temperature of the part during each step of the drying process; (38) the presence of an enclosure around the part during each step of the drying process; (39) the type of enclosure surrounding the part during drying; and/or (40) the solvents used in each step of the drying process.

Some of the present laminates have opposing front and back surfaces and comprise one or more, optionally two or more, thermally-insulative layers. In some laminates, each of the thermally-insulative layer(s) has a thermal conductivity that is less than or equal to 0.05 Watts per meter-Kelvin (W/m·K). In some laminates, each of the thermally-insulative layer(s) has a thermal diffusivity that is less than or equal to 0.15 square millimeters per second (mm²/s). In some laminates, each of the thermally-insulative layer(s) has a thickness that is less than or equal to 254 micrometers (μm).

At least one of the thermally-insulative layer(s), in some laminates, comprises a layer of polymeric aerogel. In some laminates, for at least one of the thermally-insulative layer(s), the layer of polymeric aerogel comprises an open-cell structure and/or comprises micropores, mesopores, and/or macropores. In some laminates, for at least one of the thermally-insulative layer(s), the layer of polymeric aerogel has a pore volume and at least 10%, at least 50%, at least 75%, or at least 95% of the pore volume is made up of micropores, made up of mesopores, is made up of macropores, or is made up of micropores and/or mesopores. For at least one of the thermally-insulative layer(s), in some laminates, the layer of polymeric aerogel has an average pore diameter that is between 2.0 nm and 50 nm. In some laminates, for at least one of the thermally-insulative layer(s), the layer of polymeric aerogel has an average pore diameter that is between 50 nm and 5,000 nm, optionally between 100 nm and 500 nm, and/or a median pore diameter that is between 50 nm and 5,000 nm, optionally between 250 and 600 nm. In some laminates, for at least one of the thermally-insulative layer(s), the layer of polymeric aerogel comprises at least 90% by weight of an organic polymer and/or at least 90% by weight of polyimide, polyamide, polyaramid, polyurethane, polyurea, and/or polyester. For at least one of the thermally-insulative layer(s), in some laminates, the layer of polymeric aerogel comprises at least 90% by weight of polyimide. In some laminates, for at least one of the thermally-insulative layer(s), the layer of polymeric aerogel has a thickness that is between 75 and 200 μm, optionally approximately 165 μm. For at least one of the thermally-insulative layer(s), in some laminates, the layer of polymeric aerogel has a decomposition temperature that is greater than or equal to 400° C., greater than or equal to 450° C., or greater than or equal to 500° C. and/or a coefficient of thermal expansion of the layer of polymeric aerogel is less than or equal to 40 μm/m·K. In some laminates, for at least one of the thermally-insulative layer(s), a plurality of fibers are dispersed or embedded in the layer of polymeric aerogel.

Some laminates comprise one or more, optionally two or more, adhesive layers coupled to the thermally-insulative layer(s). In some laminates, a first one of the adhesive layer(s) defines at least a portion of the back surface of the laminate. The first adhesive layer, in some embodiments, comprises a pressure-sensitive adhesive, the pressure-sensitive adhesive optionally comprising silicone, acrylic, and/or rubber. Each of the adhesive layer(s), in some laminates, has a thickness that is less than or equal to 50 μm, optionally between 15 and 35 μm. In some laminates having two or more thermally-insulative layers and two or more adhesive layers, at least one of the adhesive layers is disposed between adjacent ones of the thermally-insulative layers.

Some laminates comprise a protective layer coupled to the thermally-insulative layer(s). The protective layer, in some laminates, define at least a portion of the front surface of the laminate. In some laminates, the protective layer has a thickness that is between 12 and 200 μm and/or a thermal conductivity that is at least 3.5 times the thermal conductivity of each of the thermally-insulative layer(s). The protective layer, in some laminates, comprises molybdenum and optionally has a thickness that is between 12 and 77 μm. In some laminates, the protective layer comprises graphite and optionally has a thickness that is between 35 and 127 μm. In some laminates, the protective layer comprises a polyimide layer and optionally has a thickness that is less than or equal to 51 μm. In some of such laminates, the protective layer comprises an aluminum layer disposed on the polyimide layer and defining at least a portion of the front surface of the laminate, the aluminum layer optionally having a thickness that is less than or equal to 500 nanometers. In some laminates, the protective layer comprises carbon black particles dispersed in the polyimide layer and/or a surface resistivity of the protective layer is between 10⁵ and 10¹² ohms/square. In some laminates having two or more adhesive layers, a second one of the adhesive layers is disposed between and in contact with the protective layer and one of the thermally-insulative layer(s).

Some laminates comprise a liner layer removably disposed on the first adhesive layer, the liner layer defining at least a portion of the back surface of the laminate. The liner layer, in some laminates, comprises a polymeric film.

Some laminates have a flammability rating of UL 94 VTM-0. Some laminates have a thickness that is less than or equal to 500 μm. Some laminates are disposed in a roll such that a portion of the front surface of the laminate faces a portion of the back surface of the laminate.

Some systems comprise a surface and one of the present laminates. In some systems, the first adhesive layer of the laminate is disposed on the surface. The surface, in some systems, comprises a metal, optionally comprising aluminum, molybdenum, and/or stainless steel, or a polymer. Some systems comprise a vehicle that includes the surface. The vehicle, in some systems, is an aircraft or a spacecraft. Some systems comprise a missile, rocket, artillery round, or other projectile that includes the surface.

The term “aerogel” refers to a class of materials that are generally produced by forming a gel, removing a mobile interstitial solvent phase from the pores, and then replacing it with a gas or gas-like material. By controlling the gel and evaporation system, density, shrinkage, and pore collapse can be minimized. Aerogels of the present invention can include macropores, mesopores, and/or micropores. In preferred aspects, the majority (e.g., more than 50%) of the aerogel's pore volume can be made up of macropores. In other alternative aspects, the majority of the aerogel's pore volume can be made up of mesopores and/or micropores such that less than 50% of the aerogel's pore volume is made up of macropores. In some embodiments, the aerogels of the present invention can have low bulk densities (about 0.75 g/cm³ or less, preferably about 0.01 g/cm³ to about 0.5 g/cm³), high surface areas (generally from about 10 m²/g to 1,000 m²/g and higher, preferably about 50 m²/g to about 1000 m²/g), high porosities (about 20% and greater, preferably greater than about 85%), and/or relatively large pore volumes (more than about 0.3 mL/g, preferably about 1.2 mL/g and higher).

The presence of macropores, mesopores, and/or micropores in the aerogels of the present invention can be determined by mercury intrusion porosimetry (MIP) and/or gas physisorption experiments. The MIP test can be used to measure mesopores and macropores (i.e., American Standard Testing Method (ASTM) D4404-10, Standard Test Method for Determination of Pore Volume and Pore Volume Distribution of Soil and Rock by Mercury Intrusion Porosimetry). Gas physisorption experiments can be used to measure micropores (i.e., ASTM D1993-03(2008) Standard Test Method for Precipitated Silica—Surface Area by Multipoint BET Nitrogen).

A material's “decomposition temperature” is a temperature at which 2%, 5%, or 10% of a sample of the material, when heated in an environment raised to the temperature, decomposes. The decomposition temperature can be measured by placing the sample in a thermogravimetric analyzer (TGA), heating the sample from ambient temperature in the TGA (e.g., at a rate of 10° C./min), and recording the temperature at which the sample's mass is 2%, 5%, or 10% lower than its initial mass as its decomposition temperature.

The term “coupled” is defined as connected, although not necessarily directly, and not necessarily mechanically. Two items that are “coupled” may be unitary with each other or may be connected to one another via one or more intermediate components or elements.

The terms “a” and “an” are defined as one or more unless this disclosure explicitly requires otherwise.

The term “substantially” is defined as largely, but not necessarily wholly, what is specified (and includes what is specified; e.g., substantially 90 degrees includes 90 degrees, and substantially parallel includes parallel), as understood by a person of ordinary skill in the art. In any disclosed embodiment, the terms “substantially,” “approximately,” and “about” may be substituted with “within [a percentage] of” what is specified, where the percentage is 1, 1, 5, or 10%.

The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and containing”) are open-ended linking verbs. As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any embodiment of any of the apparatuses and methods can consist of or consist essentially of—rather than comprise/have/include/contain—any of the described elements, features, and/or steps. Thus, in any of the claims, the phrase “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate identical structures. Rather, the same reference numbers may be used to indicate similar features or features with similar functionalities, as may non-identical reference numbers.

FIG. 1 is a cross-sectional view of a first embodiment of the present laminates having an adhesive layer attaching the laminate to a surface.

FIG. 2 is a cross-sectional view of a second embodiment of the present laminates having a liner layer that is removably disposed on an adhesive layer of the laminate, the liner layer defining at least a portion of the back surface of the laminate.

FIG. 3 is a perspective view of a roll of the laminate of FIG. 2.

### DETAILED DESCRIPTION

### A. Thermal-Protection Laminates and Systems Incorporating the Same

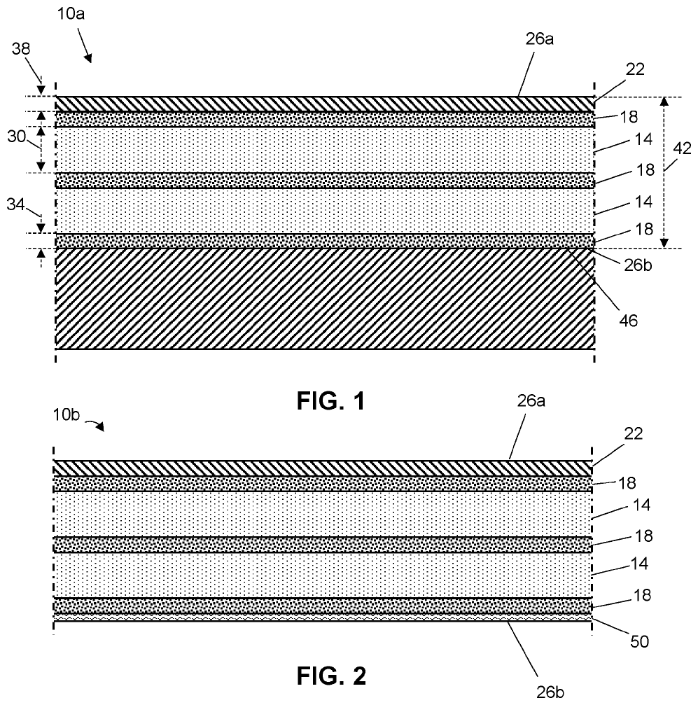

Referring to FIG. 1, shown is a first embodiment 10a of the present laminates attached to a surface 46, the laminate having opposing front and back surfaces 26a and 26b. Laminate 10a can include one or more thermally-insulative layers 14 and one or more adhesive layers 18, such as greater than or equal to any one of, or between any two of, 1, 2, 3, 4, 5, 6, 7, 8, or 9 thermally-insulative layers and can also include greater than or equal to any one of, or between any two of, 1, 2, 3, 4, 5, 6, 7, 8, or 9 adhesive layers. A first one of adhesive layer(s) 18 can define at least a portion (e.g., at least a majority, up to and including all) of back surface 26b such that the first adhesive layer can adhere laminate 10a to surface 46 when it is disposed on the surface. Additionally, laminate 10a can include a protective layer 22 defining at least a portion (e.g., at least a majority, up to and including all) of front surface 26a. Adhesive layer(s) 18 are, however, optional. To illustrate, ones of the present laminates that do not include such a first adhesive layer can be coupled to a surface (e.g., 46) via mechanical force, such as, for example, by wrapping such a laminate around the surface. Further, any recitation of “first,” “second,” or “third” adhesive layer in the claims, by itself, requires nothing more than a single adhesive layer.

As shown, laminate 10a includes two thermally-insulative layers 14, three adhesive layers 18, and a protective layer 22, with substantially all of front and back surfaces 26a and 26b defined by the protective layer and first adhesive layer, respectively. In other embodiments, however, a laminate can include a single thermally-insulative layer 14 and/or a single adhesive layer 18, and/or can omit protective layer 22. Furthermore, in some embodiments laminate 10a need not have an adhesive layer 18 defining at least a portion of its back surface 26b.

Each of thermally-insulative layer(s) 14 can mitigate heat propagation for thermal protection of surface 46. For example, each of thermally-insulative layer(s) 14 can have a thermal conductivity that is less than or equal to any one of, or between any two of, 0.06, 0.05, 0.045, 0.040, 0.035, 0.030, 0.025, 0.020, 0.015, or 0.010 Watts per meter-Kelvin (W/m·K) (e.g., less than or equal to 0.025 W/m·K) and/or a thermal diffusivity that is less than or equal to any one of, or between any two of, 0.30, 0.20, 0.15, 0.125, 0.10, 0.09, 0.08, 0.07, 0.06, or 0.05 square millimeters per second (mm²/s) (e.g., less than or equal to 0.15 mm²/s or less than or equal to 0.10 mm²/s). As used herein, a layer's or laminate's thermal conductivity is measured pursuant to ASTM C518, and the layer's or laminate's specific heat capacity—a value needed to determine the layer's or laminate's thermal diffusivity—is measured pursuant to either ASTM E1269 or ASTM C1784, and both measurements are performed at 25° C.

Additionally, each of thermally-insulative layer(s) 14 can be heat-resistant and/or have a low coefficient of thermal expansion such that laminate 10a can withstand heating when used and resist expansion for applications in which the laminate is subject to tight space constraints. For example, each of thermally-insulative layer(s) 14 can have a decomposition temperature that is greater than or equal to any one of, or between any two of, 400, 425, 450, 475, 500, 525, 550, 575, or 600° C. (e.g., greater than or equal to 450° C.) and/or a coefficient of thermal expansion (e.g., in at least one direction) that is less than or equal to any one of, or between any two of, 40, 35, 30, 25, 20, 15, 10, or 5 μm/m·K (e.g., less than or equal to 40 μm/m·K).

To achieve such properties, at least one—up to and including each—of thermally-insulative layer(s) 14 can comprise a layer of polymeric aerogel, such as one comprising at least 90% by weight of an organic polymer such as polyimide, polyaramid, polyurethane, polyrea, and/or polyester (e.g., polyimide). Each polymeric aerogel layer can have micropores, mesopores, and/or macropores. Greater than or equal to any one of, or between any 10%, 25%, 50%, 75%, or 95% of a pore volume of each aerogel layer can be made up of micropores, mesopores, and/or macropores (e.g., of micropores, of mesopores, of micropores and mesopores, or of macropores). An average pore diameter and/or median pore diameter of each aerogel layer can be greater than or equal to any one of, or between any two of, 50, 100, 150, 200, 250, 300, 350, 400, 450, 500, 800, 1,000, 2,000, 3,000, 4,000, or 5,000 nm (e.g., the average pore diameter can be between 100 and 500 nm and the median pore diameter can be between 250 and 600 nm). Materials of and processes for making layers of polymeric aerogels are explained in further detail in Sections B and C below.

In some embodiments, for at least one (e.g., each) of thermally-insulative layer(s) 14, the aerogel layer can include reinforcing fibers, which can be dispersed throughout (e.g., as chopped or discontinuous fibers not arranged in a sheet) or embedded in (e.g., as a woven, nonwoven, or unidirectional sheet of fibers) the aerogel layer, optionally such that the volume of the fibers is greater than or equal to any one of, or between any two of, 0.1%, 10%, 20%, 30%, 40%, or 50% of the aerogel layer's volume. However, the aerogel layer(s) need not comprise fibers (e.g., to promote flexibility).

Suitable fibers include glass fibers, carbon fibers, aramid fibers, thermoplastic fibers, thermoset fibers, ceramic fibers, basalt fibers, rock wool fibers, steel fibers, cellulosic fibers, and/or the like. An average filament cross-sectional area of the fibers used for reinforcement can be greater than or equal to any one of, or between any two of, 7, 15, 30, 60, 100, 200, 300, 400, 500, 600, 700, or 800 μm²; for example, for fibers with a circular cross-section, an average diameter of the fibers can be greater than or equal to any one of, or between any two of, 3, 4, 5, 6, 7, 8, 9, 10, 11, 12, 13, 14, 15, 16, 17, 18, 19, 20, 21, 22, 23, 24, 25, 26, 27, 28, 29, or 30 μm (e.g., between 5 and 24 μm, such as between 10 and 20 μm or between 12 and 15 μm).

Non-limiting examples of thermoplastic polymers that can be used for polymeric reinforcing fibers include polyethylene terephthalate (PET), polycarbonate (PC), polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) and their derivatives, thermoplastic elastomer (TPE), terephthalic acid (TPA) elastomers, poly(cyclohexanedimethylene terephthalate) (PCT), polyethylene naphthalate (PEN), polyamide (PA), polysulfone sulfonate (PSS), sulfonates of polysulfones, polyether ether ketone (PEEK), polyether ketone (PEKK), acrylonitrile butyldiene styrene (ABS), polyphenylene sulfide (PPS), co-polymers thereof, polyesters or derivatives thereof, polyamides or derivatives thereof (e.g., nylon), or blends thereof.

Non-limiting examples of thermoplastic polymers that can be used as a material for polymeric reinforcing fibers include unsaturated polyester resins, polyurethanes, polyoxybenzylmethylenglycolanhydride (e.g., Bakelite), urea-formaldehyde, diallyl-phthalate, epoxy resin, epoxy vinylesters, polyimides, cyanate esters of polycyanurates, dicyclopentadiene, phenolics, benzoxazines, co-polymers thereof, or blends thereof.

While each of thermally-insulative layer(s) 14 can comprise a layer of polymeric aerogel, in other embodiments at least one—up to and including each—of the thermally-insulative layer(s) can any suitable thermally-insulative material, such as a layer of fibers, a layer of fibers (e.g., fiberglass) attached to a superstrate (e.g., via an adhesive, such as a silicone adhesive), such as a stainless steel, aluminum, graphite, molybdenum, glass, or polymer superstrate. At least one-up to and including each of thermally-insulative layer(s) 14 can also comprise a layer of fibers laminated to a layer of polymeric aerogel, optionally such that the layer of fibers is disposed closer to front surface 26a of laminate 10a than is the layer of aerogel. The fibers in a layer of fibers can be any of those described above for the aerogel fiber-reinforcement (e.g., glass fibers and/or basalt fibers) and can be arranged in a variety of fibrous structures. For example, the fibers can form a fiber matrix, as in felt, batting lofty batting, a mat, a woven fabric, a non-woven fabric. The fibers can be unidirectionally or omnidirectionally oriented.

In some embodiments, the fibers used as reinforcement in an aerogel layer or in a layer of fibers can have an average filament cross-sectional area from 5 μm² to 40,000 μm² and/or an average length of 20 mm to 100 mm.

To permit use of laminate 10a in applications having tight space constraints, each of thermally-insulative layer(s) 14 (e.g., aerogel layer(s)) can be relatively thin. For example, a thickness 30 of at least one (e.g., each) of thermally-insulative layer(s) 14 (e.g., aerogel layer(s)) can be less than or equal to any one of, or between any two of, 510, 475, 450, 425, 400, 375, 350, 325, 300, 275, 250, 225, 200, 175, 150, 125, 100, or 75 μm, preferably less than or equal to 254 μm (e.g., between 75 and 200 μm, such as approximately 165 μm).

Protective layer 22, as an outer-facing surface of laminate 10a, can, in addition to physically protecting other layers of the laminate, further facilitate the laminate's ability to mitigate heat transfer therethrough. For example, protective layer 22 can have a thermal conductivity that is higher than that of each of thermally-insulative layer(s) 14—such as at least 3, 4, 5, 6, 7, 8, 9, 10, 15, 20, 25, or 30 times (e.g., at least 3.5 times or at least 10 times) the thermal conductivity of each of the thermally-insulative layer(s)—to facilitate heat distribution across front surface 26a and thereby mitigate heat concentrations in laminate 10a. Additionally or alternatively, a density of protective layer 22 can be higher than that of each of thermally-insulative layer(s) 14—such as at such as at least 5, 6, 7, 8, 9, 10, 15, 20, 25, 30, 40, or 50 times the density of each of the thermally-insulative layer(s)—which can promote laminate 10a's thermal diffusivity.

Protective layer 22 can comprise any suitable material for this purpose. For example, protective layer 22 can comprise a polyimide layer (e.g., comprising at least 90%, by weight, polyimide). Such a polyimide layer can optionally include a conductive filler such as carbon black dispersed in the polyimide, optionally such that the surface resistivity of protective layer 22 is between 10⁵ and 10¹² ohms/square. Additionally or alternatively, protective layer 22 can include an aluminum layer disposed on the polyimide layer and defining at least a portion (e.g., at least a majority, up to and including all) of front surface 26a; for example, the aluminum layer can be vacuum deposited on the polyimide layer, rendering it relatively thin (e.g., with a thickness of less than or equal to any one of, or between any two of, 500, 450, 400, 350, 300, 250, 200, 150, or 100 nm). Protective layer 26 can also comprise graphite and/or a metal (e.g., a metal foil), such as molybdenum, aluminum, stainless steel, steel, carbon steel, copper, brass, Monel®, a superalloy (e.g., Hastelloy®, Inconel®, Waspaloy®, Rene 41@, Incoloy®, SPS® MP98T, a CMSX single crystal alloy, and/or the like), and/or the like.

As with thermally-conductive layer(s) 14, protective layer 22 can be relatively thin. For example, a thickness 38 of protective layer 22 can be less than or equal to any one of, or between any two of, 300, 250, 200, 150, 100, 85, 70, 55, 40, 25, or 12 μm (e.g., between 12 and 200 μm). Different thicknesses can be advantageous for different protective layer materials. For example, when protective layer 22 comprises polyimide (with or without filler and/or an aluminum layer), thickness 38 can advantageously be less than or equal to any one of, or between any two of, 51, 40, 30, or 20 μm (e.g., approximately 25 μm). A molybdenum protective layer 22 can advantageously have a similar or larger thickness 38, such as one that is less than or equal to any one of, or between any two of, 77, 70, 60, 50, 40, 30, 20, or 12 μm (e.g., between 12 and 77 μm). As another example, a graphite protective layer 22 can advantageously have a larger thickness 38, such as one that is less than or equal to any one of, or between any two of, 127, 120, 110, 100, 90, 80, 70, 60, 50, 40, or 30 μm (e.g., between 35 and 127 μm).

While as shown laminate 10a includes a protective layer 22, in other embodiments the laminate need not have the protective layer. In such other embodiments, one of thermally-insulative layer(s) 14 can define at least a portion (e.g., at least a majority, up to and including all) of front surface 26a of laminate 10a.

When laminate 10a includes multiple thermally-insulative layers 14 and/or a protective layer 22, the laminate can include multiple adhesive layers 18, with the first adhesive layer defining at least a portion of back surface 26b to permit adhesion to surface 46 as described above and the remainder of the adhesive layers bonding the thermally-insulative and/or protective layers together. To do so, each of adhesive layers 18 other than the first adhesive layer can be disposed between and in contact with adjacent ones of the other laminate layers (e.g., between two of thermally-insulative layers 14 and/or between one of the thermally-conductive layers and protective layer 22). As shown, a second one of adhesive layers 18 is disposed between and in contact with protective layer 22 and one of thermally-insulative layers 14 and a third one of the adhesive layers is disposed between and in contact with two of the thermally-insulative layers. To facilitate adhesion without adding substantial thickness to laminate 10a, a thickness 34 of at least one (e.g., each) of adhesive layer(s) 18 can be less than or equal to any one of, or between any two of, 50, 45, 40, 35, 30, 25, 20, 15, or 10 μm (e.g., between 15 and 35 μm).

At least one—up to and including each—of adhesive layer(s) 18 can comprise a pressure-sensitive adhesive, such as one comprising silicone, acrylic, and/or rubber. Such a pressure-sensitive adhesive, when used for first adhesive layer 18, may permit ready application of laminate 10a to a surface 46 for thermal protection thereof (e.g., by simply pressing laminate 10a against the surface). However, at least one of adhesive layer(s) 18 can comprise a different type of adhesive, such as fluoropolymer films, polyimide films, and B-stage epoxies; examples include commercially-available adhesives such as FEP Film, Pyralux® HT, and Pyralux® GPL from DuPont™ and TSU510S-A from Toyochem Co., LTD. (Tokyo, Japan). With such other adhesives, bonding can be achieved by stacking laminate 10a's layers (e.g., 14, 18, 22) and applying heat and/or pressure to the stack (e.g., with a press), optionally such that the temperature thereof exceeds the glass transition temperature of adhesive layer(s) 18. In some embodiments with multiple adhesive layers 18, some of the adhesive layers (e.g., the first adhesive layer) can comprise a pressure-sensitive adhesive and others (e.g., those other than the first adhesive layer) can comprise another type of adhesive, like those listed above.

The composition of adhesive layer(s) 18 can mitigate the risk of delamination, such as through heat resistance. For example, at least one (e.g., each) of adhesive layer(s) 18 can have a decomposition temperature that is greater than or equal to any one of, or between any two of, 350, 375, 400, 425, 450, or 500° C. Additionally, at least one (e.g., each) of adhesive layer(s) 18 can have a glass transition temperature or a melting point that is greater than or equal to any one of, or between any two of, 100, 150, 175, 200, 225, 250, or 275° C.

With the above-described constructions, laminate 10a can provide thermal protection in high-temperature environments. For example, a thermal diffusivity of laminate 10a can be less than or equal to any one of, or between any two of, 0.15, 0.125, 0.10, 0.09, 0.08, 0.07, 0.06, 0.05, or 0.04 mm²/s (e.g., less than or equal to 0.10 mm²/s, such as less than or equal to 0.075 mm²/s), thereby mitigating heat propagation therethrough. Surprisingly, laminate 10a's thermal diffusivity can be lower than that of each of thermally-insulative layer(s) 14 even when the laminate includes a protective layer 22 having a thermal conductivity higher than that of each of the thermally-insulative layer(s).

Provided by way of illustration, a thermal conductivity of laminate 10a can be less than or equal to any one of, or between any two of: 0.025, 0.030, 0.035, 0.040, 0.045, 0.050, 0.055, or 0.060 W/m·K, and/or a specific heat capacity of the laminate can be greater than or equal to any one of, or between any two of: 0.40, 0.45, 0.50, 0.55, 0.60, 0.65, 0.70, 0.75, 0.80, 0.90, 1.00, 1.10, 1.20, 1.25, 1.30, 1.35, or 1.40 J/g K.

Furthermore, a flammability rating of laminate 10a can be UL 94 VTM-0 such that it resists burning. Systems in which such thermal protection is advantageous include, for example, vehicles, and particularly aircraft and spacecraft such as rockets that are subject to high-temperature environments. Surface 46 to which laminate 10a is attached can be a surface of a vehicle such as an aircraft or spacecraft, or can be a surface of a missile, rocket, artillery round, or other projectile, and can comprise, for example, a metal (e.g., aluminum, stainless steel, molybdenum, steel, carbon steel, copper, brass, Monel®, a superalloy, and/or the like) and/or a polymer (e.g., a fiber-reinforced polymer, such as one reinforced with carbon, aramid, and/or glass fibers). In some embodiments, surface 46 can comprise titanium and/or nickel. Laminate 10a can thus provide thermal protection to surface 46.

Furthermore, while a total thickness 42 of laminate 10a can be less than or equal to 0.50 inches, the laminate can advantageously be relatively thin as described above, such as less than or equal to any one of, or between any two of, 2540, 2000, 1500, 1000, 500, 400, 300, or 200 μm (e.g., less than or equal to 1000 μm or less than or equal to 500 μm). Such thinness may allow laminate 10a to be used in small spaces, such as those that are often in vehicles like aircraft and spacecraft, while still providing the above-described thermal protection. Laminate 10a can thus provide better thermal protection in size-constrained applications than traditional insulative materials, which may not be able to meet or may sacrifice thermal protection to meet the size constraints.

Referring to FIG. 2, shown is a second laminate 10b that is substantially similar to laminate 10a, the primary exception being that laminate 10b includes a liner layer 50. As shown, laminate 10b is not yet attached to a surface 46. To protect first adhesive layer 18 before it is adhered to surface 46 (e.g., against contaminants that may compromise its adhesiveness), liner layer 50 can be removably disposed on the first adhesive layer such that at least a portion (e.g., at least a majority, up to and including all) of back surface 26b of laminate 10b is defined by the liner layer. Liner layer 50 can comprise, for example, a polymeric film or a paper sheet and can be removed from first adhesive layer 18 by, for example, peeling it away from laminate 10b.

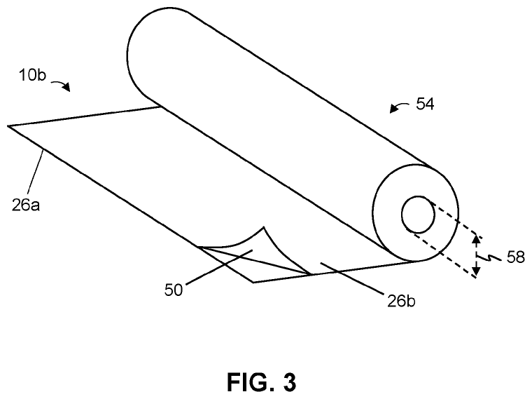

Referring additionally to FIG. 3, a laminate (e.g., 10a or 10b) can be flexible. To illustrate, laminate 10b can be capable of being disposed in a roll 54 having an inner diameter 58 of less than or equal to any one of, or between any two of, 10 cm, 8 cm, 5 cm, 4 cm, 2 cm, or 1 cm without suffering permanent deformation. Such flexibility—even if not rising to the level of this example—can be provided by the materials of the laminate's thermally-insulative, adhesive, and other (if present) layers and/or the relatively small thicknesses of those layers (e.g., those discussed above). When in a roll 54, a portion of the laminate's front surface 26a can face a portion of its back surface 26b.

### B. Materials of Layers of Polymeric Aerogel

A layer of polymeric aerogel can include organic materials, inorganic materials, or a mixture thereof. Organic aerogels can be made from polyacrylates, polystyrenes, polyacrylonitriles, polyurethanes, polyurea, polyimides, polyamides, polyaramids, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, agarose, and the like. In particular embodiments the aerogel is a polyimide aerogel.

Polyimides are a type of polymer with many desirable properties. Polyimide polymers include a nitrogen atom in the polymer backbone, where the nitrogen atom is connected to two carbonyl carbons, such that the nitrogen atom is somewhat stabilized by the adjacent carbonyl groups. A carbonyl group includes a carbon, referred to as a carbonyl carbon, which is double bonded to an oxygen atom. Polyimides are usually considered an AA-BB type polymer because usually two different classes of monomers are used to produce the polyimide polymer. Polyimides can also be prepared from AB type monomers. For example, an aminodicarboxylic acid monomer can be polymerized to form an AB type polyimide. Monoamines and/or mono anhydrides can be used as end capping agents if desired.

One class of polyimide monomer is usually a diamine, or a diamine monomer. The diamine monomer can also be a diisocyanate, and it is to be understood that an isocyanate could be substituted for an amine in this description, as appropriate. There are other types of monomers that can be used in place of the diamine monomer, as known to those skilled in the art. The other type of monomer is called an acid monomer, and is usually in the form of a dianhydride. In this description, the term “di-acid monomer” is defined to include a dianhydride, a tetraester, a diester acid, a tetracarboxylic acid, or a trimethylsilyl ester, all of which can react with a diamine to produce a polyimide polymer. Dianhydrides are to be understood as tetraesters, diester acids, tetracarboxylic acids, or trimethylsilyl esters that can be substituted, as appropriate. There are also other types of monomers that can be used in place of the di-acid monomer, as known to those skilled in the art.

Because one di-acid monomer has two anhydride groups, different diamino monomers can react with each anhydride group so the di-acid monomer may become located between two different diamino monomers. The diamine monomer contains two amine functional groups; therefore, after the first amine functional group attaches to one di-acid monomer, the second amine functional group is still available to attach to another di-acid monomer, which then attaches to another diamine monomer, and so on. In this manner, the polymer backbone is formed. The resulting polycondensation reaction forms a polyamic acid.

The polyimide polymer is usually formed from two different types of monomers, and it is possible to mix different varieties of each type of monomer. Therefore, one, two, or more di-acid monomers can be included in the reaction vessel, as well as one, two, or more diamino monomers. The total molar quantity of di-acid monomers is kept about the same as the total molar quantity of diamino monomers if a long polymer chain is desired. Because more than one type of diamine or di-acid can be used, the various monomer constituents of each polymer chain can be varied to produce polyimides with different properties. For example, a single diamine monomer AA can be reacted with two di-acid co monomers, B₁B₁ and B₂B₂, to form a polymer chain of the general form of (AA-B₁B₁)ₓ-(AA-B₂B₂)_{y} in which x and y are determined by the relative incorporations of B₁B₁ and B₂B₂ into the polymer backbone. Alternatively, diamine co-monomers A₁A₁ and A₂A₂ can be reacted with a single di-acid monomer BB to form a polymer chain of the general form of (A₁A₁-BB)ₓ-(A₂A₂-BB)_{y}. Additionally, two diamine co-monomers A₁A₁ and A₂A₂ can be reacted with two di-acid co-monomers B₁B₁ and B₂B₂ to form a polymer chain of the general form (A₁A₁-B₁B₁)_{w}-(A₁A₁-B₂B₂)ₓ-(A₂A₂-B₁B₁)_{y}-(A₂A₂-B₂B₂)_{z}, where w, x, y, and z are determined by the relative incorporation of A₁A₁-B₁B₁, A₁A₁-B₂B₂, A₂A₂-B₁B₁, and A₂A₂-B₂B₂ into the polymer backbone. More than two di-acid co-monomers and/or more than two diamine co-monomers can also be used. Therefore, one or more diamine monomers can be polymerized with one or more di-acids, and the general form of the polymer is determined by varying the amount and types of monomers used.

There are many examples of monomers that can be used to make polymeric aerogels containing polyamic amide polymer. In some embodiments, the diamine monomer is a substituted or unsubstituted aromatic diamine, a substituted or unsubstituted alkyldiamine, or a diamine that can include both aromatic and alkyl functional groups. A non-limiting list of possible diamine monomers comprises 4,4′-oxydianiline (ODA), 3,4′-oxydianiline, 3,3′-oxydianiline, p-phenylenediamine, m-phenylenediamine, o-phenylenediamine, diaminobenzanilide, 3,5-diaminobenzoic acid, 3,3′-diaminodiphenylsulfone, 4,4′-diaminodiphenyl sulfones, 1,3-bis-(4-aminophenoxy)benzene, 1,3-bis-(3-aminophenoxy)benzene, 1,4-bis-(4-aminophenoxy)benzene, 1,4-bis-(3-aminophenoxy)benzene, 2,2-bis[4-(4-aminophenoxy)phenyl]-hexafluoropropane, 2,2-bis(3-aminophenyl)-1,1,1,3,3,3-hexafluoropropane, 4,4′-isopropylidenedianiline, 1-(4-aminophenoxy)-3-(3-aminophenoxy)benzene, 1-(4-aminophenoxy)-4-(3-aminophenoxy)benzene, bis-[4-(4-aminophenoxy)phenyl]sulfones, 2,2-bis[4-(3-aminophenoxy)phenyl]sulfones, bis(4-[4-aminophenoxy]phenyl)ether, 2,2′-bis-(4-aminophenyl)-hexafluoropropane (6F-diamine), 2,2′-bis-(4-phenoxyaniline)isopropylidene, meta-phenylenediamine, para-phenylenediamine, 1,2-diaminobenzene, 4,4′-diaminodiphenylmethane, 2,2-bis(4-aminophenyl)propane, 4,4′diaminodiphenyl propane, 4,4′-diaminodiphenyl sulfide, 4,4′-diaminodiphenylsulfone, 3,4′diaminodiphenyl ether, 4,4′-diaminodiphenyl ether, 2,6-diaminopyridine, bis(3-aminophenyl)diethyl silane, 4,4′-diaminodiphenyl diethyl silane, benzidine, dichlorobenzidine, 3,3′-dimethoxybenzidine, 4,4′-diaminobenzophenone, N,N-bis(4-aminophenyl)-n-butylamine, N,N-bis(4-aminophenyl)methylamine, 1,5-diaminonaphthalene, 3,3′-dimethyl-4,4′-diaminobiphenyl, 4-aminophenyl-3-aminobenzoate, N,N-bis(4-aminophenyl)aniline, bis(p-beta-amino-t-butylphenyl)ether, p-bis-2-(2-methyl-4-aminopentyl)benzene, p-bis(1,1-dimethyl-5-aminopentyl)benzene, 1,3-bis(4-aminophenoxy)benzene, m-xylenediamine, p-xylenediamine, 4,4′-diaminodiphenyl ether phosphine oxide, 4,4′-diaminodiphenyl N-methyl amine, 4,4′-diaminodiphenyl N-phenyl amine, amino-terminal polydimethylsiloxanes, amino-terminal polypropyleneoxides, amino-terminal polybutyleneoxides, 4,4′-Methylenebis(2-methylcyclohexylamine), 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, and 4,4′-methylenebisbenzeneamine, 2,2′-dimethylbenzidine, (also known as 4,4′-diamino-2,2′-dimethylbiphenyl (DMB)), bisaniline-p-xylidene, 4,4′-bis(4-aminophenoxy)biphenyl, 3,3′-bis(4 aminophenoxy)biphenyl, 4,4′-(1,4-phenylenediisopropylidene)bisaniline, and 4,4′-(1,3-phenylenediisopropylidene)bisaniline, or combinations thereof. In a specified embodiment, the diamine monomer is ODA, 2,2′-dimethylbenzidine, or both.

A non-limiting list of possible dianhydride (“diacid”) monomers includes hydroquinone dianhydride, 3,3′,4,4′-biphenyltetracarboxylic dianhydride (BPDA), pyromellitic dianhydride (PMDA), 3,3′,4,4′-benzophenonetetracarboxylic dianhydride, 4,4′-oxydiphthalic anhydride, 3,3′,4,4′-diphenylsulfonetetracarboxylic dianhydride, 4,4′-(4,4′-isopropylidenediphenoxy)bis(phthalic anhydride), 2,2-bis(3,4-dicarboxyphenyl)propane dianhydride, 4,4′-(hexafluoroisopropylidene)diphthalic anhydride, bis(3,4-dicarboxyphenyl) sulfoxide dianhydride, polysiloxane-containing dianhydride, 2,2′,3,3′-biphenyltetracarboxylic dianhydride, 2,3,2′,3′-benzophenonetetraearboxylic dianhydride, naphthalene-2,3,6,7-tetracarboxylic dianhydride, naphthalene-1,4,5,8-tetracarboxylie dianhydride, 4,4′-oxydiphthalic dianhydride, 3,3′,4,4′-biphenylsulfone tetracarboxylic dianhydride, 3,4,9,10-perylene tetracarboxylic dianhydride, bis(3,4-dicarboxyphenyl)sulfide dianhydride, bis(3,4-dicarboxyphenyl)methane dianhydride, 2,2-bis(3,4-dicarboxyphenyl)propane dianhydride, 2,2-bis(3,4-dicarboxyphenyl)hexafluoropropane, 2,6-dichloronaphthalene-1,4,5,8-tetracarboxylic dianhydride, 2,7-dichloronapthalene-1,4,5,8-tetracarboxylic dianhydride, 2,3,6,7-tetrachloronaphthalene-1,4,5,8-tetracarboxylic dianhydride, phenanthrene, 8,9,10-tetracarboxylic dianhydride, pyrazine-2,3,5,6-tetracarboxylic dianhydride, benzene-1,2,3,4-tetracarboxylic dianhydride, and thiophene-2,3,4,5-tetracarboxylic dianhydride. In a specific embodiment, the dianhydride monomer is BPDA, PMDA, or both.

In some aspects, the molar ratio of anhydride to total diamine is from 0.4:1 to 1.6:1, 0.5:1 to 1.5:1, 0.6:1 to 1.4:1, 0.7:1 to 1.3:1, or specifically from 0.8:1 to 1.2:1. In further aspects, the molar ratio of dianhydride to multifunctional amine (e.g., triamine) is 2:1 to 140:1, 3:1 to 130:1, 4:1 to 120:1, 5:1 to 110:1, 6:1 to 100:1, 7:1 to 90:1, or specifically from 8:1 to 80:1. Mono-anhydride groups can also be used. Non-limiting examples of mono-anhydride groups include 4-amino-1,8-naphthalic anhydride, endo-bicyclo[2.2.2]oct-5-ene-2,3-dicarboxylic anhydride, citraconic anhydride, trans-1,2-cyclohexanedicarboxylic anhydride, 3,6-dichlorophthalic anhydride, 4,5-dichlorophthalic anhydride, tetrachlorophthalic anhydride 3,6-difluorophthalic anhydride, 4,5-difluorophthalic anhydride, tetrafluorophthalic anhydride, maleic anhydride, 1-cyclopentene-1,2-dicarboxylic anhydride, 2,2-dimethylglutaric anhydride 3,3-dimethylglutaric anhydride, 2,3-dimethylmaleic anhydride, 2,2-dimethylsuccinic anhydride, 2,3-diphenylmaleic anhydride, phthalic anhydride, 3-methylglutaric anhydride, methylsuccinic anhydride, 3-nitrophthalic anhydride, 4-nitrophthalic anhydride, 2,3-pyrazinedicarboxylic anhydride, or 3,4-pyridinedicarboxylic anhydride. Specifically, the mono-anhydride group can be phthalic anhydride.

In another embodiment, the polymer compositions used to prepare layers of polymeric aerogel include multifunctional amine monomers with at least three primary amine functionalities. The multifunctional amine may be a substituted or unsubstituted aliphatic multifunctional amine, a substituted or unsubstituted aromatic multifunctional amine, or a multifunctional amine that includes a combination of an aliphatic and two aromatic groups, or a combination of an aromatic and two aliphatic groups. A non-limiting list of possible multifunctional amines include propane-1,2,3-triamine, 2-aminomethylpropane-1,3-diamine, 3-(2-aminoethyl)pentane-1,5-diamine, bis(hexamethylene)triamine, N′,N′-bis(2-aminoethyl)ethane-1,2-diamine, N′,N′-bis(3-aminopropyl)propane-1,3-diamine, 4-(3-aminopropyl)heptane-1,7-diamine, N′,N′-bis(6-aminohexyl)hexane-1,6-diamine, benzene-1,3,5-triamine, cyclohexane-1,3,5-triamine, melamine, N-2-dimethyl-1,2,3-propanetriamine, diethylenetriamine, 1-methyl or 1-ethyl or 1-propyl or 1-benzyl-substituted diethylenetriamine, 1,2-dibenzyldiethylenetriamine, lauryldiethylenetriamine, N-(2-hydroxypropyl)diethylenetriamine, N,N-bis(1-methylheptyl)-N-2-dimethyl-1,2,3-propanetriamine, 2,4,6-tris(4-(4-aminophenoxy)phenyl)pyridine, N,N-dibutyl-N-2-dimethyl-1,2,3-propanetriamine, 4,4′-(2-(4-aminobenzyl)propane-1,3-diyl)dianiline, 4-((bis(4-aminobenzyl)amino)methyl)aniline, 4-(2-(bis(4-aminophenethyl)amino)ethyl)aniline, 4,4′-(3-(4-aminophenethyl)pentane-1,5-diyl)dianiline, 1,3,5-tris(4-aminophenoxy)benzene (TAPOB), 4,4′,4″-methanetriyltrianiline, N,N,N′,N′-Tetrakis(4-aminophenyl)-1,4-phenylenediamine, a polyoxypropylenetriamine, octa(aminophenyl)polyhedral oligomeric silsesquioxane, or combinations thereof. A specific example of a polyoxypropylenetriamine is JEFFAMINE® T-403 from Huntsman Corporation, The Woodlands, TX USA. In a specific embodiment, the aromatic multifunctional amine may be 1,3,5-tris(4-aminophenoxy)benzene or 4,4′,4″-methanetriyltrianiline. In some embodiments, the multifunctional amine includes three primary amine groups and one or more secondary and/or tertiary amine groups, for example, N′,N′-bis(4-aminophenyl)benzene-1,4-diamine.

Non-limiting examples of capping agents or groups include amines, maleimides, nadimides, acetylene, biphenylenes, norbornenes, cycloalkyls, and N-propargyl and specifically those derived from reagents including 5-norbornene-2,3-dicarboxylic anhydride (nadic anhydride, NA), methyl-nadic anhydride, hexachloro-nadic anhydride, cis-4-cyclohexene-1,2-dicarboxylic anhydride, 4-amino-N-propargylphthalimide, 4-ethynylphthalic anhydride, and maleic anhydride.

The characteristics or properties of the final polymer are significantly impacted by the choice of monomers that are used to produce the polymer. Factors to be considered when selecting monomers include the properties of the final polymer, such as the flexibility, thermal stability, coefficient of thermal expansion (CTE), coefficient of hydroscopic expansion (CHE), and any other properties specifically desired, as well as cost. Often, certain important properties of a polymer for a particular use can be identified. Other properties of the polymer may be less significant, or may have a wide range of acceptable values; so many different monomer combinations could be used.

In some instances, the backbone of the polymer can include substituents. The substituents (e.g., oligomers, functional groups, etc.) can be directly bonded to the backbone or linked to the backbone through a linking group (e.g., a tether or a flexible tether). In other embodiments, a compound or particles can be incorporated (e.g., blended and/or encapsulated) into the polyimide structure without being covalently bound to the polyimide structure. In some instances, the incorporation of the compound or particles can be performed during the polyamic reaction process. In some instances, particles can aggregate, thereby producing polyimides having domains with different concentrations of the non-covalently bound compounds or particles.

Specific properties of a polyimide can be influenced by incorporating certain compounds into the polyimide. The selection of monomers is one way to influence specific properties. Another way to influence properties is to add a compound or property modifying moiety to the polyimide.

### C. Preparation of Layers of Polymeric Aerogel

Polymeric aerogel films that can be used in at least some of the present laminates are commercially-available. Non-limiting examples of such films include the Blueshift AeroZero® rolled thin film (available from Blueshift Materials, Inc. (Spencer, Massachusetts) and Airloy® films (available from Aerogel Technologies, LLC), with the Blueshift AeroZero® rolled thin film being preferred in some aspects.

Further, and in addition to the processes discussed below, polymeric aerogels (films, stock shapes or monoliths, etc.) can be made using the methodology described in International Patent Application Publication Nos. WO 2014/189560 to Rodman et al., 2017/0355829 to Sakaguchi et al., 2018/078512 to Yang et al., 2018/140804 to Sakaguchi et al., and 2019/006184 to Irvin et al., International Patent Application No. PCT/US2019/029191 to Ejaz et al., U.S. Patent Application Publication No. 2017/0121483 to Poe et al., and/or U.S. Pat. No. 9,963,571 to Sakaguchi et al., all of which are incorporated herein by reference in their entireties.

The following provides non-limiting processes that can be used to make layers of polymeric aerogel suitable for use in the present laminates. These processes can include: (1) preparation of the polymer gel; (2) optional solvent exchange, (3) drying of the polymeric solution to form the aerogel; and (4) attaching a polymeric aerogel film on a substrate.

### 1. Formation of a Polymer Gel

The first stage in the synthesis of an aerogel can be the synthesis of a polymerized gel. For example, if a polyimide aerogel is desired, at least one acid monomer can be reacted with at least one diamino monomer in a reaction solvent to form a polyamic acid. As discussed above, numerous acid monomers and diamino monomers may be used to synthesize the polyamic acid. In one aspect, the polyamic acid is contacted with an imidization catalyst in the presence of a chemical dehydrating agent to form a polymerized polyimide gel via an imidization reaction. “Imidization” is defined as the conversion of a polyimide precursor into an imide. Any imidization catalyst suitable for driving the conversion of polyimide precursor to the polyimide state is suitable. Non-limiting examples of chemical imidization catalysts include pyridine, methylpyridines, quinoline, isoquinoline, 1,8-diazabicyclo[5.4.0]undec-7-ene (DBU), triethylenediamine, lutidine, N-methylmorpholine, triethylamine, tripropylamine, tributylamine, other trialkylamines, 2-methyl imidazole, 2-ethyl-4-methylimidazole, imidazole, other imidazoles, and combinations thereof. Any dehydrating agent suitable for use in formation of an imide ring from an amic acid precursor is suitable for use in the methods of the present invention. Preferred dehydrating agents comprise at least one compound selected from the group consisting of acetic anhydride, propionic anhydride, n-butyric anhydride, benzoic, anhydride, trifluoroacetic anhydride, phosphorus trichloride, and dicyclohexylcarbodiimide.

In one aspect of the current invention, one or more diamino monomers and one or more multifunctional amine monomers are premixed in one or more solvents and then treated with one or more dianhydrides (e.g., di-acid monomers) that are added in sequentially smaller amounts at pre-defined time increments while monitoring the viscosity. The desired viscosity of the polymerized solution can range from 50 to 20,000 cP or specifically 500 to 5,000 cP. By performing the reaction using incremental addition of dianhydride while monitoring viscosity, a non-crosslinked aerogel can be prepared. For instance, a triamine monomer (23 equiv.) can be added to the solvent to give a 0.0081 molar solution. To the solution, a first diamine monomer (280 equiv.) can be added, followed by a second diamine monomer (280 equiv.). Next a dianhydride (552 total equiv.) can be added in sequentially smaller amounts at pre-defined time increments while monitoring the viscosity. The dianhydride can be added until the viscosity reaches 1,000 to 1,500 cP. For example, a first portion of dianhydride can be added, the reaction can be stirred (e.g., for 20 minutes), a second portion of dianhydride can be added, and a sample of the reaction mixture can then be analyzed for viscosity. After stirring for additional time (e.g., for 20 minutes), a third portion of dianhydride can be added, and a sample can be taken for analysis of viscosity. After further stirring for a desired period of time (e.g., 10 hours to 12 hours), a mono-anhydride (96 equiv.) can be added. After having reached the target viscosity, the reaction mixture can be stirred for a desired period of time (e.g., 10 hours to 12 hours) or the reaction is deemed completed.

The reaction temperature for the gel formation can be determined by routine experimentation depending on the starting materials. In a preferred embodiment, the temperature can be greater than or equal to any one of, or between any two of: 15° C., 20° C., 30° C., 35° C., 40° C., and 45° C. After a desired amount of time (e.g., about 2 hours), the product can be isolated (e.g., filtered), after which a nitrogen-containing hydrocarbon (828 equiv.) and dehydration agent (1214 equiv.) can be added. The addition of the nitrogen-containing hydrocarbon and/or dehydration agent can occur at any temperature. In some embodiments, the nitrogen-containing hydrocarbon and/or dehydration agent is added to the solution at 20° C. to 28° C. (e.g., room temperature) and stirred for a desired amount of time at that temperature. In some instances, after addition of nitrogen-containing hydrocarbon and/or dehydration agent, the solution temperature is raised up to 150° C.

The reaction solvent can include dimethylsulfoxide (DMSO), diethylsulfoxide, N,N-dimethylformamide (DMF), N,N-diethylformamide, N,N-dimethylacetamide (DMAc), N,N-diethylacetamide, N-methyl-2-pyrrolidone (NMP), 1-methyl-2-pyrrolidinone, N-cyclohexyl-2-pyrrolidone, 1,13-dimethyl-2-imidazolidinone, diethyleneglycoldimethoxyether, o-dichlorobenzene, phenols, cresols, xylenol, catechol, butyrolactones, hexamethylphosphoramide, and mixtures thereof. The reaction solvent and other reactants can be selected based on the compatibility with the materials and methods applied; i.e., if the polymerized polyamic amide gel is to be cast onto a support film, injected into a moldable part, or poured into a shape for further processing into a workpiece. In a specific embodiment, the reaction solvent is DMSO.

While keeping the above in mind, the introduction of macropores into the aerogel polymeric matrix, as well as the amount of such macropores present, can be performed in the manner described in the Summary. In one non-limiting manner, the formation of macropores versus smaller mesopores and micropores can be primarily controlled by controlling the polymer/solvent dynamics during gel formation. By doing so, the pore structure can be controlled, and the quantity and volume of macroporous, mesoporous, and microporous cells can be controlled. For example, a curing additive that reduces the solubility of the polymers being formed during polymerization, such as 1,4-diazabicyclo[2.2.2]octane, can produce a polymer gel containing a higher number of macropores as compared to another curing additive that improves the resultant polymer solubility, such as triethylamine. In another specific non-limiting example, when forming a polyimide aerogel, increasing the ratio of rigid amines (e.g., p-phenylenediamine (p-PDA)) to more flexible diamines (e.g., -ODA) incorporated into the polymer backbone can favor the formation of macropores over smaller mesopores and micropores.

The polymer solution may optionally be cast onto a casting sheet covered by a support film for a period of time. Casting can include spin casting, gravure coating, three roll coating, knife over roll coating, slot die extrusion, dip coating, Meyer rod coating, or other techniques. In one embodiment, the casting sheet is a polyethylene terephthalate (PET) casting sheet. After a passage of time, the polymerized reinforced gel is removed from the casting sheet and prepared for the solvent exchange process. In some embodiments, the cast film can be heated in stages to elevated temperatures to remove solvent and convert the amic acid functional groups in the polyamic acid to imides with a cyclodehydration reaction, also called imidization. In some instances, polyamic acids may be converted in solution to polyimides with the addition of the chemical dehydrating agent, catalyst, and/or heat.

In some embodiments, the polyimide polymers can be produced by preparing a polyamic acid polymer in the reaction vessel. The polyamic acid is then formed into a sheet or a film and subsequently processed with catalysts or heat and catalysts to convert the polyamic acid to a polyimide.

Wet gels used to prepare aerogels may be prepared by any known gel-forming techniques, for example adjusting the pH and/or temperature of a dilute metal oxide sol to a point where gelation occurs.

### 2. Optional Solvent Exchange

After the polymer gel is synthesized, it may be desirable in certain instances to conduct a solvent exchange wherein the reaction solvent is exchanged for a more desirable second solvent. Accordingly, in one embodiment, a solvent exchange can be conducted wherein the polymerized gel is placed inside of a pressure vessel and submerged in a mixture comprising the reaction solvent and the second solvent. Then, a high-pressure atmosphere is created inside of the pressure vessel, thereby forcing the second solvent into the polymerized gel and displacing a portion of the reaction solvent. Alternatively, the solvent exchange step may be conducted without the use of a high-pressure environment. It may be necessary to conduct a plurality of rounds of solvent exchange. In some embodiments, solvent exchange is not necessary.

The time necessary to conduct the solvent exchange will vary depending upon the type of polymer undergoing the exchange as well as the reaction solvent and second solvent being used. In one embodiment, each solvent exchange can take from 1 to 168 hours or any period time there between, including 2, 3, 4, 5, 6, 7, 8, 9, 10, 11, 12, 13, 14, 15, 16, 17, 18, 19, 20, 21, 22, or 23, 24, 25, 50, 75, 100, 125, 150, 155, 160, 165, 166, 167, or 168 hours. In another embodiment, each solvent exchange can take approximately 1 to 60 minutes, or about 30 minutes. Exemplary second solvents include methanol, ethanol, 1-propanol, 2-propanol, 1-butanol, 2-butanol, isobutanol, tert-butanol, 3-methyl-2-butanol, 3,3-dimethyl-2-butanol, 2-pentanol, 3-pentanol, 2,2-dimethylpropan-1-ol, cyclohexanol, diethylene glycol, cyclohexanone, acetone, acetyl acetone, 1,4-dioxane, diethyl ether, dichloromethane, trichloroethylene, chloroform, carbon tetrachloride, water, and mixtures thereof. In certain non-limiting embodiments, the second solvent can have a suitable freezing point for performing supercritical or subcritical drying steps. For example, tert-butyl alcohol has a freezing point of 25.5° C. and water has a freezing point of 0° C. under one atmosphere of pressure. Alternatively, and as discussed below, however, the drying can be performed without the use of supercritical or subcritical drying steps, such as by evaporative drying techniques.

The temperature and pressure used in the solvent exchange process may be varied. The duration of the solvent exchange process can be adjusted by performing the solvent exchange at a varying temperatures or atmospheric pressures, or both, provided that the pressure and temperature inside the pressure vessel do not cause either the first solvent or the second solvent to leave the liquid phase and become gaseous phase, vapor phase, solid phase, or supercritical fluid. Generally, higher pressures and/or temperatures decrease the amount of time required to perform the solvent exchange, and lower temperatures and/or pressures increase the amount of time required to perform the solvent exchange.

### 3. Cooling and Drying

In one embodiment, after solvent exchange, the polymerized gel can be exposed to supercritical drying. In this instance, the solvent in the gel can be removed by supercritical CO₂ extraction.

In another embodiment, after solvent exchange, the polymerized gel can be exposed to subcritical drying. In this instance, the gel can be cooled below the freezing point of the second solvent and subjected to a freeze drying or lyophilization process to produce the aerogel. For example, if the second solvent is water, then the polymerized gel is cooled to below 0° C. After cooling, the polymerized gel can be subjected to a vacuum for a period of time to allow sublimation of the second solvent.

In still another embodiment, after solvent exchange, the polymerized gel can be exposed to subcritical drying with optional heating after the majority of the second solvent has been removed through sublimation. In this instance the partially dried gel material is heated to a temperature near or above the boiling point of the second solvent for a period of time. The period of time can range from a few hours to several days, although a typical period of time is approximately 4 hours. During the sublimation process, a portion of the second solvent present in the polymerized gel is removed, leaving a gel that can have macropores, mesopores, or micropores, or any combination thereof or all of such pore sizes. After the sublimation process is complete, or nearly complete, the aerogel has been formed.

In yet another embodiment after solvent exchange, the polymerized gel can be dried under ambient conditions, for example, by removing the solvent under a stream of gas (e.g., air, anhydrous gas, inert gas (e.g., nitrogen (N₂) gas), etc.). Still further, passive drying techniques can be used such as simply exposing the gel to ambient conditions without the use of a gaseous stream.

Once cooled or dried, the films and stock shapes can be configured for use in the present laminates. For example, the films or stock shapes can be processed into desired shapes (e.g., by cutting or grinding) such as square shapes, rectangular shapes, circular shapes, triangular shapes, irregular shapes, random shapes, etc. Also, and as discussed above, the films or stock shapes can be affixed to a support material such as with an adhesive. In alternative embodiments, a support material can be incorporated into the matrix of the polymeric aerogel, which is discussed below.

4. Incorporation of a Reinforcing Layer into the Matrix of the Polymeric Aerogel

In addition to the methods discussed above with respect to the use of adhesives for attaching a polymeric aerogel to a support material, an optional embodiment of the present invention can include incorporation of the support material into the polymeric matrix to create a reinforced polymeric aerogel without the use of adhesives. Notably, during manufacture of a non-reinforced polymer aerogel, a reinforcing support film can be used as a carrier to support the gelled film during processing. During rewinding, the gelled film can be irreversibly pressed into the carrier film. Pressing the gelled film into the carrier film can provide substantial durability improvement. In another instance, during the above-mentioned solvent casting step, the polymer solution can be cast into a reinforcement or support material.

The substrate selection and direct casting can allow optimization of (e.g., minimization) of the thickness of the resulting reinforced aerogel material. This process can also be extended to the production of fiber-reinforced polymer aerogels—internally reinforced polyimide aerogels are provided as an example. The process can include: (a) forming a polyamic acid solution from a mixture of dianhydride and diamine monomers in a polar solvent such as DMSO, DMAc, NMP, or DMF; (b) contacting the polyamic acid solution with chemical curing agents listed above and a chemical dehydrating agent to initiate chemical imidization; (c) casting the polyamic acid solution onto a fibrous support prior to gelation and allow it to permeate it; (d) allowing the catalyzed polyamic acid solution to gel around, and into, the fibrous support during chemical imidization; (e) optionally performing a solvent exchange, which can facilitate drying; and (f) removal of the transient liquid phase contained within the gel with supercritical, subcritical, or ambient drying to give an internally reinforced aerogel.

### EXAMPLES

The present invention will be described in greater detail by way of specific examples. The following examples are offered for illustrative purposes only and are not intended to limit the invention in any manner. Those of ordinary skill in the art will readily recognize a variety of noncritical parameters, which can be changed or modified to yield essentially the same results.

### Example 1

### Thermal Diffusivity of Exemplary Laminates

Four laminates were produced and the thermal diffusivity of each was measured. Each of the laminates had a single thermally-insulative layer that was a 165-μm-thick AeroZero® polyimide aerogel. Laminate 1 had a Kapton® polyimide film protective layer defining its front surface and two 25-μm-thick silicone pressure-sensitive adhesive layers, a first one of the adhesive layers disposed on the AeroZero® polyimide aerogel and defining Laminate 1's back surface and a second one of the adhesive layers bonding the protective layer to the aerogel layer. Laminates 2 and 3 were substantially the same as Laminate 1, except that their protective layers were layers of graphite and aluminum, respectively. Laminate 4 only included the AeroZero® aerogel layer defining the laminate's front surface and a 25-μm-thick silicone pressure-sensitive adhesive layer disposed on the aerogel layer and defining the laminate's back surface. The thermal diffusivity of a single 165-μm-thick AeroZero® polyimide aerogel layer was also measured as a comparison. TABLE 1, below, shows the results.

TABLE 1
Thermal Diffusivities of Exemplary Laminates

| | Thermal |
|---|---|
| | Diffusivity |
| | (mm²/s) |
| AeroZero ® Aerogel | 0.120 |
| Laminate 1 | 0.050 |
| Laminate 2 | 0.073 |
| Laminate 3 | 0.070 |
| Laminate 4 | 0.063 |

Each of the laminates had a lower thermal diffusivity than that of the AeroZero® polyimide aerogel layer alone. This was surprising, given that that the laminates each added to a AeroZero® polyimide aerogel layer one or more layers of material—i.e., Kapton®, silicone, graphite, and/or aluminum-having higher thermal conductivities than that of the AeroZero® polyimide aerogel layer.

As part of these thermal-diffusivity measurements, for each of the laminates and the AeroZero® polyimide aerogel layer, its thermal conductivity was measured pursuant to ASTM C518, and its specific heat capacity was measured pursuant to ASTM E1269, with each of those measurements being conducted at 25° C. These thermal-conductivity and specific-heat-capacity measurements, as well as the densities of the laminates and the AeroZero® polyimide aerogel layer, are provided below in TABLE 2.

TABLE 2
Properties of the Exemplary Laminates

| | Thermal | Specific Heat | |
|---|---|---|---|
| | Conductivity | Capacity | Density |
| | (W/m K) | (J/g K) | (g/cm³) |
| AeroZero ® Aerogel | 0.034 | 1.0 | 0.28 |
| Laminate 1 | 0.039 | 1.3 | 0.58 |
| Laminate 2 | 0.047 | 1.1 | 0.61 |
| Laminate 3 | 0.047 | 0.9 | 0.79 |
| Laminate 4 | 0.038 | 1.4 | 0.44 |

### Example 2

### Thermal Diffusivity of Exemplary Laminates and Insulators

Fourteen samples of the present laminates were prepared-S1-S14-having the properties listed in TABLE 3, below.

TABLE 3
Sample Laminate Properties

| | | Overall | |
|---|---|---|---|
| | Layup | Thickness | Density |
| Laminate | (Top to Bottom) | (μm) | (g/cm³) |
| S1 | Kapton ® | 238 | 0.58 |
| | Silicone | | |
| | AeroZero ® Aerogel | | |
| | Silicone | | |
| S2 | Graphite | 274 | 0.72 |
| | Silicone | | |
| | AeroZero ® Aerogel | | |
| | Silicone | | |
| S3 | Aluminum (2.0-mils thick) | 269 | 0.88 |
| | Silicone | | |
| | AeroZero ® Aerogel | | |
| | Silicone | | |
| S4 | Aluminum (2.0-mils thick) | 244 | 0.91 |
| | Silicone | | |
| | AeroZero ® Aerogel | | |
| S5 | AeroZero ® Aerogel | 191 | 0.40 |
| | Silicone | | |
| S6 | ESD Kapton ® | 224 | 0.70 |
| | Silicone | | |
| | AeroZero ® Aerogel | | |
| | Silicone | | |
| S7 | VDA Kapton ® | 239 | 0.60 |
| | Silicone | | |
| | AeroZero ® Aerogel | | |
| | Silicone | | |
| S8 | Molybdenum | 250 | 1.40 |
| | Silicone | | |
| | AeroZero ® Aerogel | | |
| S9 | Molybdenum | 229 | 1.71 |
| | Silicone | | |
| | AeroZero ® Aerogel | | |
| | Silicone | | |
| S10 | Kapton ® (0.5-mils thick) | 179 | 0.56 |
| | Silicone | | |
| | AeroZero ® Aerogel | | |
| S11 | Stainless Steel | 234 | 1.43 |
| | Silicone | | |
| | AeroZero ® Aerogel | | |
| | Silicone | | |
| S12 | Stainless Steel (2.0-mils thick) | 265 | 1.83 |
| | Silicone | | |
| | AeroZero ® Aerogel | | |
| S13 | Kapton ® | 264 | 0.69 |
| | Silicone | | |
| | AeroZero ® Aerogel | | |
| | Silicone | | |
| | Kapton ® | | |
| S14 | Kapton (0.5-mils thick) | 213 | 0.69 |
| | Silicone | | |
| | AeroZero ® Aerogel | | |
| | Silicone | | |
| | Kapton ® (0.5-mils thick) | | |

A single 165-μm-thick AeroZero® polyimide aerogel layer and four comparative insulators, C1-C4, were also prepared, which had the properties listed in TABLE 4, below.

TABLE 4
Insulator Properties

| | | Overall | |
|---|---|---|---|
| | Layup | Thickness | Density |
| Insulator | (Top to Bottom) | (μm) | (g/cm³) |
| AeroZero ® Aerogel | AeroZero ® Aerogel | 165 | 0.27 |
| C1 | Stainless Steel | 3,280 | 0.27 |
| | (2.0-mils thick) | | |
| | Silicone | | |
| | Fiberglass | | |
| | Silicone | | |
| C2 | Aluminum | 3,280 | 0.19 |
| | Silicone | | |
| | Fiberglass | | |
| | Silicone | | |
| C3 | VDA Kapton ® | 3,079 | 0.18 |
| | Silicone | | |
| | Fiberglass | | |
| | Silicone | | |
| C4 | Fiberglass | 3,175 | 0.14 |

The thermal diffusivities of sample laminates S1-S14, the AeroZero® polyimide aerogel layer, and comparative insulators C1-C4 and were then measured. To do so, for each of the laminates and insulators, the laminate or insulator's thermal conductivity was measured pursuant to ASTM C18, the laminate or insulator's specific heat capacity was measured pursuant to ASTM C 1784, each at 25° C., and these values were used—along with the laminate or insulator's density (TABLES 3 and 4)—to calculate the laminate or insulator's thermal diffusivity. These thermal diffusivities, as well as the thermal conductivities and specific heat capacities, are provided in TABLE 5, below.

TABLE 5
Thermal Data for Laminates S1-14 and The Insulators

| | | Specific | |
|---|---|---|---|
| Laminate | Thermal | Heat | Thermal |
| or | Conductivity | Capacity | Diffusivity |
| Insulator | (W/m K) | (J/g K) | (mm²/s) |
| S1 | 0.045 | 1.20 | 0.064 |
| S2 | 0.054 | 1.10 | 0.070 |
| S3 | 0.050 | 1.10 | 0.052 |
| S4 | 0.047 | 1.00 | 0.052 |
| S5 | 0.038 | 1.10 | 0.089 |
| S6 | 0.045 | 1.10 | 0.061 |
| S7 | 0.047 | 1.20 | 0.066 |
| S8 | 0.041 | 0.47 | 0.062 |
| S9 | 0.047 | 0.49 | 0.057 |
| S10 | 0.039 | 1.20 | 0.060 |
| S11 | 0.046 | 0.69 | 0.046 |
| S12 | 0.044 | 0.55 | 0.044 |
| S13 | 0.050 | 1.20 | 0.061 |
| S14 | 0.048 | 1.20 | 0.060 |
| AeroZero ® Aerogel | 0.034 | 1.00 | 0.130 |
| C1 | 0.030 | 0.70 | 0.150 |
| C2 | 0.032 | 1.10 | 0.150 |
| C3 | 0.029 | 0.88 | 0.190 |
| C4 | 0.030 | 0.88 | 0.250 |

As shown in TABLE 5, Example 2's experiment recovered the same result as Example 1's: the thermal diffusivity of each of laminates S1-14 was lower than that of the AeroZero® polyimide aerogel layer by itself, despite laminates S1-S14 each including one or more layers having higher thermal conductivities than that of the AeroZero® polyimide aerogel layer. Example 2 also showed another surprising result. While fiberglass's thermal conductivity was slightly lower than the AeroZero® polyimide aerogel layer's thermal conductivity (compare Table 5's AeroZero® Aerogel with C4), laminates S1-14, each of which included an AeroZero® polyimide aerogel layer, had significantly lower thermal diffusivities than did fiberglass-based insulators C1-C4.

The above specification and examples provide a complete description of the structure and use of illustrative embodiments. Although certain embodiments have been described above with a certain degree of particularity, or with reference to one or more individual embodiments, those of ordinary skill in the art could make numerous alterations to the disclosed embodiments without departing from the scope of this invention. As such, the various illustrative embodiments of the apparatuses and methods are not intended to be limited to the particular forms disclosed. Rather, they include all modifications and alternatives falling within the scope of the claims, and embodiments other than the ones shown may include some or all of the features of the depicted embodiments. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means plus- or step-plus-function limitations, unless such a limitation is explicitly recited in a given claim using the phrase(s) “means for” or “step for,” respectively.

1. A laminate comprising:
one or more thermally-insulative layers, each having a thermal conductivity that is less than or equal to 0.05 Watts per meter-Kelvin (W/m·K);
wherein the laminate comprises a thickness that is less than or equal to 500 micrometers (μm); and
wherein the laminate comprises a thermal diffusivity that is less than or equal to 0.10 square millimeters per second (mm²/s).

2. The laminate of claim 1, comprising:
a first adhesive layer coupled to the thermally-insulative layer(s);
wherein at least a portion of a back surface of the laminate is defined by:
the first adhesive layer; or
a liner layer removably disposed on the first adhesive layer.

3. The laminate of claim 1 or 2, comprising:
a protective layer coupled to the thermally-insulative layer(s) and defining at least a portion of a front surface of the laminate;
wherein the protective layer has a thickness that is between 12 and 200 μm and a thermal conductivity that is at least 3.5 times the thermal conductivity of each of the thermally-insulative layer(s).

4. The laminate of claim 3, wherein the protective layer comprises molybdenum.

5. The laminate of claim 4, wherein the thickness of the protective layer is between 12 and 77 μm.

6. The laminate of claim 3, wherein the protective layer comprises graphite.

7. The laminate of claim 6, wherein the thickness of the protective layer is between 35 and 127 μm.

8. The laminate of claim 3, wherein the protective layer comprises a polyimide layer.

9. The laminate of claim 8, wherein the protective layer comprises an aluminum layer disposed on the polyimide layer and defining at least a portion of the front surface of the laminate, the aluminum layer having a thickness that is less than or equal to 500 nanometers.

10. The laminate of claim 8, wherein:
the protective layer comprises carbon black particles dispersed in the polyimide layer; and
a surface resistivity of the protective layer is between 10⁵ and 10¹² ohms/square.

11. The laminate of any of claims 8-10, wherein the thickness of the protective layer is less than or equal to 51 μm.

12. The laminate of any of claims 3-11, comprising:
a second adhesive layer coupled to the thermally-insulative layer(s);
wherein the second adhesive layer is disposed between and in contact with the protective layer and one of the thermally-insulative layer(s).

13. The laminate of claim 2, wherein the first adhesive layer comprises a pressure-sensitive adhesive.

14. The laminate of claim 2 or 12, wherein each of the adhesive layer(s) comprises silicone, acrylic, and/or rubber.

15. The laminate of any of claims 2 or 12-14, wherein each of the adhesive layer(s) has a thickness that is less than or equal to 50 μm.

16. The laminate of claim 15, wherein the thickness of each of the adhesive layer(s) is between 15 and 35 μm.

17. The laminate of any of claims 1-16, wherein at least one of the thermally-insulative layer(s) comprises a layer of polymeric aerogel.

18. The laminate of claim 17, wherein, for at least one of the thermally-insulative layer(s), the layer of polymeric aerogel comprises an open-cell structure.

19. The laminate of claim 17 or 18, wherein, for at least one of the thermally-insulative layer(s), the layer of polymeric aerogel comprises micropores, mesopores, and/or macropores.

20. The laminate of claim 19, wherein, for at least one of the thermally-insulative layer(s):
the layer of polymeric aerogel has a pore volume; and
at least 10%, at least 50%, at least 75%, or at least 95% of the pore volume is made up of micropores.

21. The laminate of claim 19, wherein, for at least one of the thermally-insulative layer(s):
the layer of polymeric aerogel has a pore volume; and
at least 10%, at least 50%, at least 75%, or at least 95% of the pore volume is made up of mesopores.

22. The laminate of claim 19, wherein, for at least one of the thermally-insulative layer(s):
the layer of polymeric aerogel has a pore volume; and
at least 10%, at least 50%, at least 75%, or at least 95% of the pore volume is made up of macropores.

23. The laminate of claim 19, wherein, for at least one of the thermally-insulative layer(s):
the layer of polymeric aerogel has a pore volume; and
at least 10%, at least 50%, at least 75%, or at least 95% of the pore volume is made up of micropores and/or mesopores.

24. The laminate of claim 17 or 18, wherein, for at least one of the thermally-insulative layer(s), the layer of polymeric aerogel has an average pore diameter that is between 2.0 nanometers (nm) and 50 nm.

25. The laminate of claim 17 or 18, wherein, for at least one of the thermally-insulative layer(s), the layer of polymeric aerogel has:
an average pore diameter that is between 50 nm and 5,000 nm; and/or
a median pore diameter that is between 50 nm and 5,000 nm.

26. The laminate of claim 25, wherein:
the average pore diameter is between 100 nm and 500 nm; and
the median pore diameter is between 250 and 600 nm.

27. The laminate of any of claims 17-26, wherein, for at least one of the thermally-insulative layer(s), the layer of polymeric aerogel comprises at least 90% by weight of an organic polymer.

28. The laminate of any of claims 17-26, wherein, for at least one of the thermally-insulative layer(s), the layer of polymeric aerogel comprises at least 90% by weight of polyimide, polyamide, polyaramid, polyurethane, polyurea, and/or polyester.

29. The laminate of claim 28, wherein, for at least one of the thermally-insulative layer(s), the layer of polymeric aerogel comprises at least 90% by weight of polyimide.

30. The laminate of any of claims 17-29, wherein, for at least one of the thermally-insulative layer(s), the layer of polymeric aerogel has a thickness that is between 75 and 200 μm.

31. The laminate of claim 30, wherein, for at least one of the thermally-insulative layer(s), the thickness of the layer of polymeric aerogel is approximately 165 μm.

32. The laminate of any of claims 17-31, wherein, for at least one of the thermally-insulative layer(s), the layer of polymeric aerogel has a decomposition temperature that is greater than or equal to 400° C., greater than or equal to 450° C., or greater than or equal to 500° C.

33. The laminate of any of claims 17-32, wherein, for at least one of the thermally-insulative layer(s), a coefficient of thermal expansion of the layer of polymeric aerogel is less than or equal to 40 μm/m·K.

34. The laminate of any of claims 17-33, wherein, for at least one of the thermally-insulative layer(s), a plurality of fibers are dispersed or embedded in the layer of polymeric aerogel.

35. The laminate of any of claims 1-34, wherein:
the one or more thermally-insulative layers comprise two thermally-insulative layers;
the laminate comprises a third adhesive layer; and
the third adhesive layer is disposed between adjacent ones of the thermally-insulative layers.

36. The laminate of any of claims 1-35, wherein the laminate has a flammability rating of UL 94 VTM-0.

37. The laminate of claim 2, wherein the liner layer comprises a polymeric film.

38. The laminate of any of claims 1-37, wherein the laminate is disposed in a roll such that a portion of the front surface of the laminate faces a portion of the back surface of the laminate.

39. A system comprising:
a surface; and
the laminate of any of claims 1-37;
wherein the laminate is disposed on the surface.

40. The system of claim 39, wherein the surface comprises a metal, a polymer, or graphite.

41. The system of claim 40, wherein:
the surface comprises the metal; and
the metal comprises aluminum, molybdenum, stainless steel, steel, carbon steel, copper, brass, Monel®, and/or a superalloy.

42. The system of any of claims 39-41, wherein the system comprises a vehicle that includes the surface.

43. The system of claim 42, wherein the vehicle is an aircraft or a spacecraft.

44. The system of any of claims 39-41, wherein the system comprises a missile, rocket, artillery round, or other projectile that includes the surface.
